(19) United States
(12) Patent Application Publication
(10) Pub. No.: US 2020/0355489 A1
(43) Pub. Date: Nov. 12, 2020

(54) SUB-PIXEL DISPLACEMENT MEASUREMENT METHOD BASED ON TIKHONOV REGULARIZATION

(71) Applicant: SOUTHEAST UNIVERSITY, Nanjing (CN)

(72) Inventors: Dingding HE, Nanjing (CN); Chenglin ZHENG, Nanjing (CN); Qingguo FEI, Nanjing (CN)

(73) Assignee: SOUTHEAST UNIVERSITY, Nanjing (CN)

(21) Appl. No.: 16/640,354

(22) PCT Filed: Apr. 17, 2018
(86) PCT No.: PCT/CN2018/083370

§ 371 Date: Feb. 20, 2020

(30) Foreign Application Priority Data
Aug. 24, 2017 (CN) 201710733368.2

(51) Int. Cl. G01B 11/02; G06T 7/73; G06T 7/246

(52) U.S. Cl. CPC G01B 11/02; G06T 7/248; G06T 7/74

(57) ABSTRACT

A sub-pixel displacement measurement method based on a Tikhonov regularization, including the following steps: collecting two images before a structure is deformed, and recording the two images as reference images; collecting an image after the structure is deformed, and recording the image as a target image; extracting grayscale matrices in the two reference images, recording the grayscale matrices as f₀ and f₁, and calculating a noise level parameter δ of the two reference images: taking a pixel point to be measured as a center point, extracting a square region in the target image, recording a grayscale matrix of the square region as g, and using a Tikhonov regularization method to separately obtain grayscale gradient matrices of the square region along an x direction and along a y direction; and calculating a sub-pixel displacement of the structure by using the grayscale gradient matrices.

### CROSS REFERENCE TO THE RELATED APPLICATIONS

This application is the national phase entry of International Application No. PCT/CN2018/083370, filed on Apr. 17, 2018, which is based upon and claims priority to Chinese Patent Application No. 201710733368.2, filed on Aug. 24, 2017, the entire contents of which are incorporated herein by reference.

### TECHNICAL FIELD

The present disclosure relates to the field of non-contact optical measurement, and in particular to a sub-pixel displacement measurement method based on Tikhonov regularization.

### BACKGROUND

A digital image correlation method is an optical measurement method widely used in scientific research and industrial fields, and a sub-pixel displacement measurement method is one of core technologies of the digital image correlation method. A grayscale gradient of a speckle pattern needs to be obtained when the displacement of the speckle pattern is calculated by a sub-pixel displacement algorithm. A traditional calculation method is to take a derivative of a grayscale of the speckle pattern by a finite difference method, such as a central difference formula and a five-point difference formula. However, the finite difference formula has poor anti-noise capability, and when a grayscale gradient of an image is calculated, the noise of the image will be amplified, thereby reducing the measurement accuracy of the sub-pixel displacement measurement method. Meanwhile, the noise of the image is inevitable due to factors such as camera self-heating and lens distortion in an actual measurement environment. Therefore, there is a need for a grayscale gradient calculation method which is suitable for the digital image correlation method and has a strong anti-noise capability, so as to enhance the anti-noise capability of the sub-pixel displacement measurement method in the digital image correlation method.

### SUMMARY

The technical problem to be solved by the present invention is to address the disadvantages in the prior art, and a sub-pixel displacement measurement method based on Tikhonov regularization is provided.

The present invention adopts the following technical solution to solve the above technical problems.

A sub-pixel displacement measurement method based on Tikhonov regularization, including the following steps:

step 1), collecting two images before a structure is deformed, and recording the two images as reference images;

step 2), collecting an image after the structure is deformed, and recording the image as a target image;

step 3), extracting grayscale matrices in the two reference images, recording the grayscale matrices as f₀ and f₁, and calculating a noise level parameter δ of the two reference images:

$$δ = max ( \vert \frac{{f}_{0} - {f}_{1}}{2} \vert )$$

step 4), taking a pixel point to be measured as a center, extracting a square region having a size of (2N+1)×(2N+1) pixels in the target image, recording a grayscale matrix of the square region as g, and using a Tikhonov regularization method to separately obtain grayscale gradient matrices of the square region along an x direction and along a y direction, wherein N is a preset natural number greater than zero; and

step 5), calculating a sub-pixel displacement of the structure by using the grayscale gradient matrices in step 4) and a sub-pixel displacement measurement method.

As a further optimization solution of the sub-pixel displacement measurement method based on Tikhonov regularization of the present invention, the step 4) includes the following detailed steps:

step 4.1), letting a defined interval of the grayscale matrix g of the extracted square region in the target image be [0,1], and Δ={0=x₀<x₁< . . . <x_{2N}=1} be an equidistant division of the interval [0,1], and then a cubic spline functio h(x) n g being:

h(x)=aⱼ+bⱼ(x−xⱼ)+cⱼ(x−xⱼ)²+dⱼ(x−xⱼ)³, x∈[xⱼ,xⱼ₊₁], j=0,1, . . . 2N−1

wherein, aⱼ, bⱼ, cⱼ, dⱼ are coefficients to be determined of the cubic spline function, and values of the coefficients aⱼ, bⱼ, cⱼ, dⱼ, satisfy the following constraint conditions:

$$\{ \begin{matrix}{h}^{( i )} ( {x}_{j} + ) - {h}^{( i )} ( {x}_{j} - ) = 0 , i = 0 , 1 , 2 ; j = 1 , 2 , … 2 N - 1 \\ {h}^{( 3 )} ( {x}_{j} + ) - {h}^{( 3 )} ( {x}_{j} - ) = \frac{1}{{δ}^{2} ( 2 N - 1 )} ( {g}_{j} - h ( {x}_{j} ) ) , \\ j = 1 , 2 , … 2 N - 1 \\ {h}^{( 2 )} ( 0 ) = {h}^{( 2 )} ( 1 ) = 0 \\ h ( 0 ) = g ( 0 ) , h ( 1 ) = g ( 1 )\end{matrix}$$

wherein h⁽ⁱ⁾(x) is an i^{th} derivative of the function h(x);

by using the above constraint conditions, the coefficients aⱼ, bⱼ, cⱼ, dⱼ to be determined of the smooth cubic spline function can be obtained, and then the grayscale gradient matrix of the square region in the target image is obtained;

step 4.2), recording A and B as tridiagonal matrices of order (2N−1)×(2N−1):

$$A = ( \begin{matrix}\frac{4 h}{3} & \frac{h}{3} & 0 & … & \\ \frac{h}{3} & \frac{4 h}{3} & \frac{h}{3} & 0 & … \\ & … & … & … & \\ … & 0 & \frac{h}{3} & \frac{4 h}{3} & \frac{h}{3} \\ & … & 0 & \frac{h}{3} & \frac{4 h}{3}\end{matrix} )$$

$$B = ( \begin{matrix}- \frac{2}{h} & \frac{1}{h} & 0 & … & \\ \frac{1}{h} & - \frac{2}{h} & \frac{1}{h} & 0 & … \\ & … & … & … & \\ … & 0 & \frac{1}{h} & - \frac{2}{h} & \frac{1}{h} \\ & … & 0 & \frac{1}{h} & - \frac{2}{h}\end{matrix} )$$

wherein, h=1/(2N);

step 4.3): extracting a row or a column of elements in the grayscale matrix g of the square region in the target image and recording the row or the column of elements as a vector g′, wherein the vector g′ is represented as g′=(g′₀, g′₁, . . . g′_{2N}), with a total of 2N+1 elements;

wherein, when the column of elements of the g is extracted, a grayscale gradient along a matrix column direction is calculated, and when a row of elements of the g is extracted, a grayscale gradient along a matrix row direction is calculated;

a, c, y, and z are recorded as the following 2N−1-dimensional column vectors:

$$a = {( {a}_{1} , {a}_{2} , … {a}_{2 N - 1} )}^{T}$$

$$c = {( {c}_{1} , {c}_{2} , … {c}_{2 N - 1} )}^{T}$$

$$y = {( {g}_{1}^{′} , {g}_{2}^{′} , … {g}_{2 N - 1}^{′} )}^{T} \\ z = {( \frac{{g}_{0}^{′}}{h} , 0 , … 0 , \frac{{g}_{2 N}^{′}}{h} )}^{T}$$

wherein, a₁, a₂, . . . a_{2N-1} and c₁, c₂, . . . c_{2N-1} are coefficients to be determined of the cubic spline function, g′₁, g′₂, . . . g∝_{2N-1} are elements respectively corresponding to subscripts 1, 2, . . . and 2N−1 in the vector g′, and g′₀,g′_{2N} are elements respectively corresponding to subscripts 0 and 2N in the vector g′;

according to the constraint conditions, the following can be obtained:

c=(A+2δ₂(2N−1)B²)⁻¹(By+z)

a=y−2δ²(2N−1)Bc

dⱼ=(cⱼ₊₁−cⱼ)/3h, j=0,1, . . . ,2N−1

bⱼ=(aⱼ₊₁−aⱼ)/h−cⱼh−dⱼh², j=0,1, . . . ,2N−1

wherein, bⱼ, dⱼ are coefficients to be determined of the cubic spline function, wherein bⱼ is a grayscale gradient of the square region in the target image.

As a further optimization solution of the sub-pixel displacement measurement method based on Tikhonov regularization of the present invention, the step 5) includes the following detailed steps:

step 5.1), constructing a correlation function:

$$C = {\sum }_{y = - N}^{N} {\sum }_{x = - N}^{N} {[ f ( x , y ) - g ( {x}^{′} , {y}^{′} ) ]}^{2}$$

wherein:

x′=x+uₓΔx+u_{y}Δy

y′=y+vₓΔx+v_{y}Δy

wherein f (x, y) is a grayscale of a point at a coordinate of (x, y) in the square region of the reference images, and g(x′, y′) is a grayscale of a point at a coordinate of (x′, y′) in the square region of the target image; and u, v are sub-pixel displacement components of a center point of the square region in the x and y directions, and uₓ, u_{y}, vₓ, v_{y} are first-order displacement gradient of the square region in the x and y directions;

step 5.2), the correlation function being a function about p=(u, uₓ, u_{y}, v, vₓ, v_{y}), and finding a minimum value of the correlation function through a Newton-Raphson iterative formula:

$${p}^{( k + 1 )} = {p}^{( k )} - \frac{∇ C ( {p}^{( k )} )}{∇ ∇ C ( {p}^{( k )} )}$$

wherein, an iterative initial value is p₀=(u₀, 0, 0, v₀, 0, 0), and u₀, v₀ are whole-pixel displacements obtained by a whole-pixel displacement algorithm;

$$∇ C = {( \frac{\partial C}{\partial {p}_{i}} )}_{i = 1 , … , 6} = - 2 {\sum }_{x = - N}^{N} {\sum }_{y = - N}^{N} {\{ ( f - g ) \frac{\partial g}{\partial {p}_{i}} \}}_{i = 1 , … , 6}$$

$$∇ ∇ C = {( \frac{{\partial }^{2} C}{\partial {p}_{i} \partial {p}_{j}} )}_{{i = 1 , … , 6}_{j = 1 , … , 6}} = - 2 {\sum }_{x = - N}^{N} {\sum }_{y = - N}^{N} {\{ \frac{{\partial }^{2} g}{\partial {p}_{i} \partial {p}_{j}} \}}_{{i = 1 , … , 6}_{j = 1 , … , 6}}$$

wherein, a partial derivative of the grayscale matrix g is a grayscale gradient of the square region in the target image calculated in step 2; and

step 5.3), obtaining the sub-pixel displacement of the square region in the target image through the Newton-Raphson iterative formula, wherein an iterative convergence criterion is:

|p^{(k+1)}−p^{(k)}|≤0.001.

Compared with the prior art, the above technical solution adopted the present invention has the following advantages.

Compared with the prior art, the present invention is based on the Tikhonov regularization method, the mage noise is considered, the grayscale of the speckle pattern is fitted by the smooth cubic spline function, and the derivative of the cubic spline function is used as the grayscale gradient of the speckle pattern, which overcomes the problem of poor anti-noise capability of the traditional finite difference method, and improves the anti-noise capability and measurement accuracy of the sub-pixel displacement measurement method in the digital image correlation method.

### BRIEF DESCRIPTION OF THE DRAWINGS

FIG. 1 shows a speckle pattern on a surface of a specimen;

FIG. 2 shows a comparison of mean errors between a method of the present invention and a traditional method according to the speckle pattern on the surface of the specimen; and

FIG. 3 shows a comparison of standard deviations between the method of the present invention and the traditional method according to the speckle pattern on the surface of the specimen.

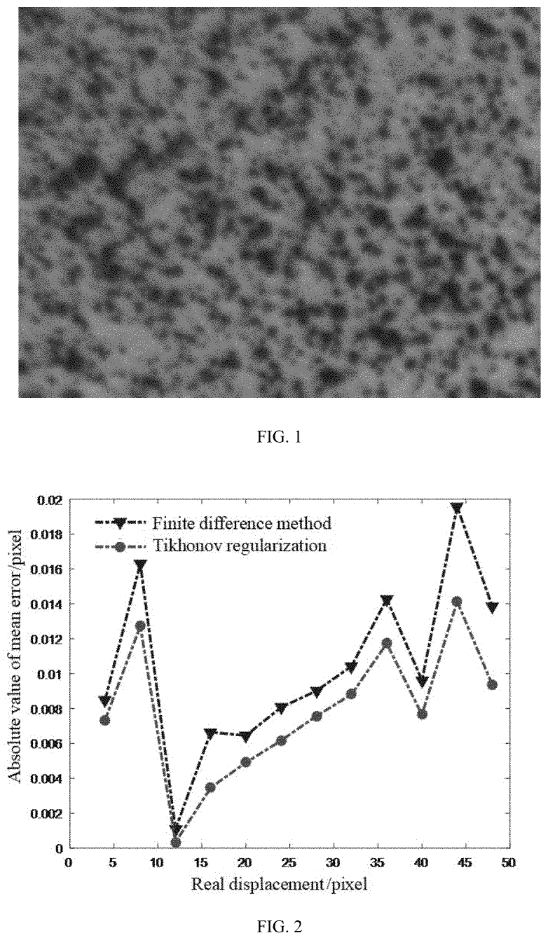

### DETAILED DESCRIPTION OF THE EMBODIMENTS

The technical solution of the present invention is further described in detail below in conjunction with the drawings:

In order to prove the effectiveness of the method in an actual measurement, a specimen with matte paint sprayed on a surface is fixed on a precision translation table, the translation was performed accurately. Speckle patterns are collected before and after the specimen is translated. The displacement of the specimen is calculated by the sub-pixel displacement measurement method based on Tikhonov regularization, and then is compared with the displacement of the specimen which is calculated by a traditional sub-pixel displacement measurement method based on a finite difference method. The specific steps are as follows.

1) In this embodiment, the pixel of a camera is 300*400 pixels, a speckled specimen is fixedly mounted on a precision translation table, and the camera is fixed, so that the specimen is clearly imaged and not out of focus. Before the specimen is translated, two images are collected and recorded as reference images, and grayscale matrices in the two reference images are extracted and recorded as f₀ and f₁, respectively. A noise level parameter δ of the two reference images is calculated by:

$$δ = max ( \vert \frac{{f}_{0} - {f}_{1}}{2} \vert ) = 0.01 \qquad ( 1 )$$

2) The object is sequentially translated by 0.02 mm, and the total translation distance is 0.34 mm. After each translation, a corresponding image is collected as a target image.

3) Taking a pixel point to be measured as a center, a square region having a size of (2N+1)×(2N+1) pixels in the target image is extracted, and a grayscale matrix of the square region is recorded as g. Let a defined interval be [0,1], and Δ={0=x₀<x₁< . . . <x_{2N}=1} be an equidistant division of the interval [0,1], wherein N is a preset natural number larger than zero; and then a cubic spline function h(x) is:

h(x)=aⱼ+bⱼ+bⱼ(x−xⱼ)+cⱼ(x−xⱼ)²+dⱼ(x−xⱼ)³, x∈[xⱼ,xⱼ₊₁], j=0,1, . . . 2N−1 (2)

wherein, aⱼ, bⱼ, cⱼ, dⱼ are coefficients to be determined of the cubic spline function, and values of the coefficients aⱼ, bⱼ, cⱼ, dⱼ satisfy the following constraint conditions:

$$\{ \begin{matrix}{h}^{( i )} ( {x}_{j} + ) - {h}^{( i )} ( {x}_{j} - ) = 0 , i = 0 , 1 , 2 ; j = 1 , 2 , … 2 N - 1 \\ {h}^{( 3 )} ( {x}_{j} + ) - {h}^{( 3 )} ( {x}_{j} - ) = \frac{1}{{δ}^{2} ( 2 N - 1 )} ( {g}_{j} - h ( {x}_{j} ) ) , j = 1 , 2 , … 2 N - 1 \\ {h}^{2} ( 0 ) = {h}^{2} ( 1 ) = 0 \\ h ( 0 ) = g ( 0 ) , h ( 1 ) = g ( 1 ) \end{matrix} \qquad ( 3 )$$

wherein, h⁽ⁱ⁾(x) is an firth derivative of h(x).

By using the above constraint conditions, the coefficients aⱼ, bⱼ, cⱼ, dⱼ to be determined of the smooth cubic spline function can be obtained, and then the grayscale gradient matrix of the square region in the target image is obtained.

A and B are recorded as tridiagonal matrices of order (2N−1)×(2N−1):

$$A = ( \begin{matrix}\frac{4 h}{3} & \frac{h}{3} & 0 & ⋯ & \\ \frac{h}{3} & \frac{4 h}{3} & \frac{h}{3} & 0 & ⋯ \\ & ⋯ & ⋯ & ⋯ & \\ ⋯ & 0 & \frac{h}{3} & \frac{4 h}{3} & \frac{h}{3} \\ & ⋯ & 0 & \frac{h}{3} & \frac{4 h}{3}\end{matrix} ) B = ( \begin{matrix}- \frac{2}{h} & \frac{1}{h} & 0 & ⋯ & \\ \frac{1}{h} & - \frac{2}{h} & \frac{1}{h} & 0 & ⋯ \\ & ⋯ & ⋯ & ⋯ & \\ ⋯ & 0 & \frac{1}{h} & - \frac{2}{h} & \frac{1}{h} \\ & ⋯ & 0 & \frac{1}{h} & - \frac{2}{h}\end{matrix} ) \qquad ( 4 )$$

wherein, h=1/(2N).

A row or a column of elements in the grayscale matrix g of the square region in the target image are extracted and recorded as g′, and then the vector g′ can be represented as g′=(g′₀, g′₁, . . . g′_{2N}), with a total of 2N+1 elements.

When a column of elements of g is extracted, a grayscale gradient along a matrix column direction is calculated, and when a row of elements of g is extracted, a grayscale gradient along a matrix row direction is calculated. a, c, y, and z are recorded as the following 2N−1-dimensional column vectors:

$$\begin{matrix}a = {( {a}_{1} , {a}_{2} , … {a}_{2 N - 1} )}^{T} & ( 5 ) \\ c = {( {c}_{1} , {c}_{2} , … {c}_{2 N - 1} )}^{T} & ( 6 ) \\ y = {( {g}_{1}^{′} , {g}_{2}^{′} , … {g}_{2 N - 1}^{′} )}^{2} & ( 7 ) \\ z = {( \frac{{g}_{0}^{′}}{h} , 0 , … 0 , \frac{{g}_{2 N}^{′}}{h} )}^{T} & ( 8 )\end{matrix}$$

wherein, a₁, a₂, . . . a_{2N-1} and c₁, c₂, . . . c_{2N-1} are coefficients to be determined of the cubic spline function, g′₁, g′₂, . . . g′_{2N-1} are elements respectively corresponding to subscripts 1, 2, . . . and 2N−1 in the vector g′, and g′₀, g′_{2N} are elements respectively corresponding to subscripts 0 and 2N in g′.

According to the constraint conditions, the following can be obtained:

c=(A+2δ₂(2N−1)B²)⁻¹(By+z) (9)

a=y−2δ²(2N−1)Bc (10)

dⱼ=(cⱼ₊₁−cⱼ)/3h, j=0,1, . . . ,2N−1 (11)

bⱼ=(aⱼ₊₁−aⱼ)/h−cⱼh−dⱼh², j=0,1, . . . ,2N−1 (12)

wherein, bⱼ, dⱼ are coefficients to be determined of the cubic spline function, wherein bⱼ is the grayscale gradient of the square region in the target image.

4) A correlation function is constructed:

$$C = {\sum }_{y = - N}^{N} {\sum }_{x = - N}^{N} {[ f ( x , y ) - g ( {x}^{′} , {y}^{′} ) ]}^{2} \qquad ( 13 )$$

wherein:

x′=x+uₓΔx+u_{y}Δy

y′=y+vₓΔx+v_{y}Δy (14)

wherein f(x, y) is a grayscale of a point at a coordinate of (x, y) in a square region of the reference images, and g(x′, y′) is a grayscale of a point at a coordinate of (x′, y′) in the square region of the target image. u,v are sub-pixel displacement components of a center point of the square region in the x and y directions, and uₓ, u_{y}, vₓ, v_{y} are first-order displacement gradient of the square region in the x and y directions.

The correlation function is a function about P=(u, uₓ, u_{y}, v, vₓ, v_{y}), and the minimum value of the correlation function is found through a Newton-Raphson iterative formula:

$${p}^{( k + 1 )} = {p}^{( k )} - \frac{∇ C ( {p}^{( k )} )}{∇ ∇ C ( {p}^{( k )} )} \qquad ( 15 )$$

wherein, an iterative initial value is p₀=(u₀, 0, 0, v₀, 0, 0), and u₀, v₀ are whole-pixel displacements obtained by a whole-pixel displacement algorithm;

$$\begin{matrix}∇ C = {( \frac{\partial C}{\partial {p}_{i}} )}_{i = 1 , … , 6} = - 2 {\sum }_{x = - N}^{N} {\sum }_{y = - N}^{N} {\{ ( f - g ) \frac{\partial g}{\partial {p}_{i}} \}}_{i = 1 , … , 6} & ( 16 ) \\ ∇ ∇ C = {( \frac{{\partial }^{2} C}{\partial {p}_{i} \partial {p}_{j}} )}_{{i = 1 , … , 6}_{j = 1 , … , 6}} = - 2 {\sum }_{x = - N}^{N} {\sum }_{y = - N}^{N} {\{ \frac{{\partial }^{2} g}{\partial {p}_{i} \partial {p}_{j}} \}}_{{i = 1 , … , 6}_{j = 1 , … , 6}} & ( 17 )\end{matrix}$$

wherein, a partial derivative of the grayscale matrix g is the grayscale gradient of the square region in the target image calculated in step 3; the sub-pixel displacement of the square region in the target image can be obtained through the Newton-Raphson iterative formula, wherein an iterative convergence criterion is:

|p^{(k+1)}−p^{(k)}|≤0.001 (18)

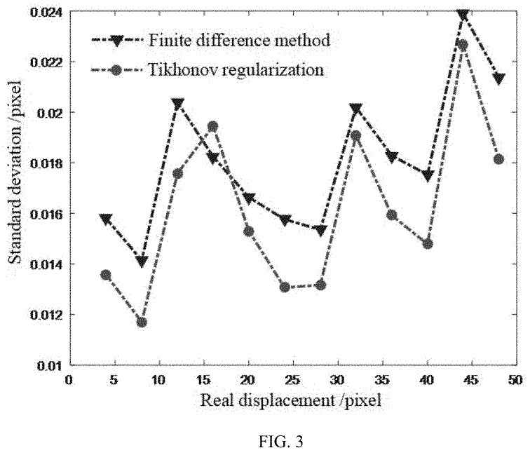

FIGS. 2 and 3 show comparisons about calculation error between the method of the present invention and the sub-pixel displacement measurement method based on the finite difference method. It can be observed from the figures that the mean error and standard deviation of the displacement of specimen calculated by the method of the present invention both are smaller than the mean error and standard deviation of the displacement of specimen calculated by the sub-pixel displacement measurement method based on the finite difference method. The results demonstrate the feasibility and effectiveness of the method of the present invention for practical experimental analysis.

It can be understood by those skilled in the art that, unless otherwise defined, all terms (including technical terms and scientific terms) used herein have the same meaning as commonly understood by one of ordinary skill in the art to which the present invention belongs. It should also be understood that, terms such as those defined in a general dictionary should be understood to have meanings consistent with the meanings in the context of the prior art, and unless defined as such herein, will not be explained in an idealized or overly formal sense.

The specific embodiments described above further describe the objectives, technical solutions, and advantages of the present invention in detail. It should be understood that the above are only specific embodiments of the present invention and are not intended to limit the present invention. Any modification, equivalent replacement, improvement or the like made within the spirit and principle of the present invention shall fall within the protective scope of the present invention.

What is claimed is:

1. A sub-pixel displacement measurement method based on a Tikhonov regularization, comprising the following steps:
step 1), collecting two images before a structure is deformed, and recording the two images as two reference images;
step 2), collecting an image after the structure is deformed, and recording the image as a target image;
step 3), extracting grayscale matrices in the two reference images, recording the grayscale matrices as f₀ and f₁, and calculating a noise level parameter δ of the two reference images:
$$δ = max ( \vert \frac{{f}_{0} - {f}_{1}}{2} \vert )$$
step 4), taking a pixel point to be measured as a center point, extracting a square region having a size of (2N+1)×(2N+1) pixels in the target image, recording a grayscale matrix of the square region in the target image as g, and using a Tikhonov regularization method to separately obtain a first grayscale gradient matrix of the square region in the target image along an x direction and a second grayscale gradient matrix of the square region in the target image along a y direction, wherein N is a preset natural number greater than zero; and
step 5), calculating a sub-pixel displacement of the structure by using the first grayscale gradient matrix and the second grayscale gradient matrix in step 4) and the sub-pixel displacement measurement method.

2. The sub-pixel displacement measurement method based on the Tikhonov regularization according to claim 1, wherein, the step 4) comprises the following steps:
step 4.1), letting a defined interval of the grayscale matrix g of the square region in the target image be [0,1], and Δ={0=x₀<x₁< . . . <x_{2N}=1} be an equidistant division of the defined interval [0,1], and then a cubic spline function h(x) being:
h(x)=aⱼ+bⱼ(x−xⱼ)+cⱼ(x−xⱼ)²+dⱼ(x−xⱼ)³, x∈[xⱼ xⱼ₊₁], j=0,1, . . . 2N−1
wherein, aⱼ, bⱼ, cⱼ, dⱼ are coefficients to be determined of the cubic spline function, and values of the coefficients aⱼ, bⱼ, cⱼ,dⱼ satisfy the following constraint conditions:
$$\{ \begin{matrix}{h}^{( i )} ( {x}_{j} + ) - {h}^{( i )} ( {x}_{j} - ) = 0 , i = 0 , 1 , 2 ; j = 1 , 2 , … 2 N - 1 \\ {h}^{( 3 )} ( {x}_{j} + ) - {h}^{( 3 )} ( {x}_{j} - ) = \frac{1}{{δ}^{2} ( 2 N - 1 )} ( {g}_{j} - h ( {x}_{j} ) ) , j = 1 , 2 , … 2 N - 1 \\ {h}^{2} ( 0 ) = {h}^{2} ( 1 ) = 0 \\ h ( 0 ) = g ( 0 ) , h ( 1 ) = g ( 1 ) \end{matrix}$$
wherein h⁽ⁱ⁾(x) is an i^{th} derivative of the cubic spline function h(x);
by using the constraint conditions, the coefficients aⱼ, bⱼ, cⱼ, dⱼ to be determined of the cubic spline function are obtained, and then the first grayscale gradient matrix of the square region in the target image is obtained;
step 4.2), recording A and B as tridiagonal matrices of order (2N−1)×(2N−1):
$$A = ( \begin{matrix}\frac{4 h}{3} & \frac{h}{3} & 0 & ⋯ & \\ \frac{h}{3} & \frac{4 h}{3} & \frac{h}{3} & 0 & ⋯ \\ & ⋯ & ⋯ & ⋯ & \\ ⋯ & 0 & \frac{h}{3} & \frac{4 h}{3} & \frac{h}{3} \\ & ⋯ & 0 & \frac{h}{3} & \frac{4 h}{3}\end{matrix} ) B = ( \begin{matrix}- \frac{2}{h} & \frac{1}{h} & 0 & ⋯ & \\ \frac{1}{h} & - \frac{2}{h} & \frac{1}{h} & 0 & ⋯ \\ & ⋯ & ⋯ & ⋯ & \\ ⋯ & 0 & \frac{1}{h} & - \frac{2}{h} & \frac{1}{h} \\ & ⋯ & 0 & \frac{1}{h} & - \frac{2}{h}\end{matrix} )$$
wherein, h=1/(2N);
step 4.3): extracting a row or a column of elements in the grayscale matrix g of the square region in the target image and recording the row or the column of elements as a vector g′, wherein the vector g′ is represented as g′=(g′₀, g′₁, . . . g′_{2N}) with a total of 2N+1 elements;
wherein, when the column of elements of the g is extracted, a grayscale gradient along a matrix column direction is calculated, and when a row of elements of the g is extracted, a grayscale gradient along a matrix row direction is calculated;
a, c, y, and z are recorded as the following 2N−1-dimensional column vectors:
$$a = {( {a}_{1} , {a}_{2} , … {a}_{2 N - 1} )}^{T}$$
$$\begin{matrix}c = {( {c}_{1} , {c}_{2} , … {c}_{2 N - 1} )}^{T} \\ y = {( {g}_{1}^{′} , {g}_{2}^{′} , … {g}_{2 N - 1}^{′} )}^{2} \\ z = {( \frac{{g}_{0}^{′}}{h} , 0 , … 0 , \frac{{g}_{2 N}^{′}}{h} )}^{T}\end{matrix}$$
wherein, a₁, a₂, . . . a_{2N-1} and c₁, c₂, . . . c_{2N-1} are coefficients to be determined of the cubic spline function, g′₁, g′₂, . . . g′_{2N-1} are elements respectively corresponding to subscripts 1, 2, . . . and 2N−1 in the vector g′, and g′₀,g′_{2N} are elements respectively corresponding to subscripts 0 and 2N in the vector g′;
according to the constraint conditions, the following is obtained:
c=(A+2δ₂(2N−1)B²)⁻¹(By+z)
a=y−2δ²(2N−1)Bc
dⱼ=(cⱼ₊₁−cⱼ)/3h, j=0,1, . . . ,2N−1
bⱼ=(aⱼ₊₁−aⱼ)/h−cⱼh−dⱼh², j=0,1, . . . ,2N−1
wherein, bⱼ, dⱼ are coefficients to be determined of the cubic spline function, wherein bⱼ is a grayscale gradient of the square region in the target image.

3. The sub-pixel displacement measurement method based on the Tikhonov regularization according to claim 1, wherein, the step 5) comprises the following steps:
step 5.1), constructing a correlation function:
$$C = {\sum }_{y = - N}^{N} {\sum }_{x = - N}^{N} {[ f ( x , y ) - g ( {x}^{′} , {y}^{′} ) ]}^{2}$$
wherein:
x′=x+uₓΔx+u_{y}Δy
y′=y+vₓΔx+v_{y}Δy
wherein f(x,y) is a grayscale of a point at a coordinate of (x,y) in a square region of each of the two reference images, and g(x′, y′) is a grayscale of a point at a coordinate of (x′, y′) in the square region of the target image; u is a sub-pixel displacement component of the center point of the square region of the target image in the x direction and v is a sub-pixel displacement component of the center point of the square region of the target image in the y direction; uₓ, vₓ, are first-order displacement gradients of the square region of the target image in the x direction and uᵥ, v_{y} are first-order displacement gradients of the square region of the target image in the y direction;
step 5.2), the correlation function being a function about p=(u, uₓ, u_{y}, v, vₓ, v_{y}), and finding a minimum value of the correlation function through a Newton-Raphson iterative formula:
$${p}^{( k + 1 )} = {p}^{( k )} - \frac{∇ C ( {p}^{( k )} )}{∇ ∇ C ( {p}^{( k )} )}$$
wherein, an iterative initial value is p₀=(u₀, 0, 0, v₀, 0, 0), and u₀, v₀ are whole-pixel displacements obtained by a whole-pixel displacement algorithm;
$$\begin{matrix}∇ C = {( \frac{\partial C}{\partial {p}_{i}} )}_{i = 1 , … , 6} = - 2 {\sum }_{x = - N}^{N} {\sum }_{y = - N}^{N} {\{ ( f - g ) \frac{\partial g}{\partial {p}_{i}} \}}_{i = 1 , … , 6} \\ ∇ ∇ C = {( \frac{{\partial }^{2} C}{\partial {p}_{i} \partial {p}_{j}} )}_{{i = 1 , … , 6}_{j = 1 , … , 6}} = - 2 {\sum }_{x = - N}^{N} {\sum }_{y = - N}^{N} {\{ \frac{{\partial }^{2} g}{\partial {p}_{i} \partial {p}_{j}} \}}_{{i = 1 , … , 6}_{j = 1 , … , 6}}\end{matrix}$$
wherein, a partial derivative of the grayscale matrix g is a grayscale gradient of the square region in the target image in step 2); and
step 5.3), obtaining a sub-pixel displacement of the square region in the target image through the Newton-Raphson iterative formula, wherein an iterative convergence criterion is:

|p^{(k+1)-}p^{(k)}|≤0.001.
